(19) United States
(12) Patent Application Publication
(10) Pub. No.: US 2024/0140611 A1
(43) Pub. Date: May 2, 2024

(54) EXHAUST SYSTEMS HAVING ADJUSTABLE NOZZLES AND RELATED METHODS

(71) Applicant: The Boeing Company, Chicago, IL (US)

(72) Inventor: Jason Boyer, Swedesboro, NJ (US)

(21) Appl. No.: 17/978,011

(22) Filed: Oct. 31, 2022

(51) Int. Cl. B64D 33/04; B64C 27/04

(52) U.S. Cl. CPC B64D 33/04; B64C 27/04; B64D 2033/045

(57) ABSTRACT

Exhaust systems having adjustable nozzles and related methods are disclosed. An example exhaust system includes a nozzle. A portion of the nozzle is moveable from a first position to a second position to change an angle of convergence of the nozzle. The example exhaust system includes an exit area. The portion of the nozzle is at least partially disposed in the exit area. An opening is defined between the exit area and the portion of the nozzle disposed in the exit area. A size of the opening is to change in response to movement of the portion of the nozzle.

### GOVERNMENT RIGHTS STATEMENT

This invention was made with Government support under W9124P-19-9-001 awarded by the Department of Defense. The government has certain rights in this invention.

### FIELD OF THE DISCLOSURE

This disclosure relates generally to engine exhaust systems and, more particularly, to exhaust systems having adjustable nozzles and related methods.

### BACKGROUND

An engine exhaust system of a vehicle such as an aircraft includes a nozzle to direct exhaust gases from the engine. The temperature of the exhaust gases influences an infrared signature of the air vehicle that can be detected by infrared sensors.

### SUMMARY

An example exhaust system includes a nozzle. A portion of the nozzle is moveable from a first position to a second position to change an angle of convergence of the nozzle. The example exhaust system includes an exit area. The portion of the nozzle is at least partially disposed in the exit area. An opening is defined between the exit area and the portion of the nozzle disposed in the exit area. A size of the opening is to change in response to movement of the portion of the nozzle

An example air vehicle includes a manifold to receive exhaust gases from an engine of the air vehicle. The example air vehicle includes a nozzle fluidly coupled to the manifold. A portion of the nozzle is moveable to adjust a size of an outlet of the nozzle. The example apparatus includes an actuator operatively coupled to the portion of the nozzle. The example apparatus includes an exit area. The outlet of the nozzle is disposed in the exit area to direct the exhaust gases into the exit area. The actuator is to cause the portion of the nozzle to move to control an amount of ambient air entering the exit area.

An example apparatus includes a nozzle including an outlet having an adjustable width. The nozzle is to provide a flow path for exhaust gases of an engine. The example apparatus includes an exit area fluidly coupled to the nozzle. The exit area is to expel the exhaust gases. An opening is defined between the exit area and a portion of the nozzle including the outlet. The opening is to receive ambient air to mix with the exhaust gases in the exit area. The example apparatus includes an actuator to control the width of the nozzle. The example apparatus includes at least one memory; machine readable instructions; and processor circuitry to execute the machine readable instructions to cause the actuator to control the width of the outlet of the nozzle to adjust a size of the opening defined between the exit area and the portion of the nozzle including the outlet

### BRIEF DESCRIPTION OF THE DRAWINGS

FIG. 1 illustrates an example air vehicle in which examples disclosed herein may be implemented.

FIG. 2 illustrates an example system including an example exhaust system having an adjustable nozzle and nozzle control circuitry for controlling one or more actuators to adjust the nozzle in accordance with teachings of this disclosure.

FIG. 3 is a side view of a manifold and a first example nozzle of the example exhaust system of FIG. 2 in accordance with teachings of this disclosure.

FIG. 4 is a perspective view of the first example nozzle of FIG. 3.

FIG. 5 is a side view of the first example nozzle of FIGS. 3 and 4.

FIG. 6 is a cross-sectional view of the first example nozzle of FIG. 5 taken along the 6-6 line of FIG. 5.

FIG. 7 is another side view of the first example nozzle of FIG. 4.

FIG. 8 is a cross-sectional view of the first example nozzle of FIG. 7 taken along the 8-8 line of FIG. 7.

FIG. 9 is a side view of a second example nozzle of the example exhaust system of FIG. 2 in accordance with teachings of this disclosure.

FIG. 10 is a side view of the manifold and a third example nozzle of the example exhaust system of FIG. 2 in accordance with teachings of this disclosure.

FIG. 11 is a perspective view of the third example nozzle of FIG. 10.

FIG. 12 is a side view of the manifold and a fourth example nozzle of the example exhaust system of FIG. 2 in accordance with teachings of this disclosure.

FIG. 13 is a perspective view of the fourth example nozzle of FIG. 12.

FIG. 14 is a flowchart of an example method to assemble the example exhaust system of FIG. 2 including one of the nozzles of FIGS. 3-13 in accordance with teachings of this disclosure.

FIG. 15 is a block diagram of the example nozzle control circuitry of FIG. 2.

FIG. 16 is a flowchart representative of example machine readable instructions and/or example operations that may be executed by example processor circuitry to implement the nozzle control circuitry of FIG. 15 to control the nozzles of FIGS. 2-13.

FIG. 17 is a block diagram of an example processing platform including processor circuitry structured to execute the example machine readable instructions and/or the example operations of FIG. 16 to implement the nozzle control circuitry of FIG. 15.

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

An engine exhaust system of an air vehicle includes a nozzle to direct exhaust gases from the engine. The temperature of the exhaust gases influences an infrared signature of the air vehicle that can be detected by infrared sensors. When an air vehicle is used for military or defense purposes in a threatening area, detection of the infrared signature due to the emission of exhaust gases and hot metal vehicle components can jeopardize the air vehicle in the case of a manned or unmanned air vehicle and/or personnel in the case of a manned air vehicle.

Some known engine exhaust systems include a nozzle having a static cross-sectional area from which the exhaust gases are emitted. However, such known exhaust nozzles result in trade-offs between engine performance and infrared signature detectability. For instance, a nozzle having a smaller cross-sectional area at, for instance, the outlet can improve the infrared signature of the air vehicle because a smaller amount of exhaust gas is emitted through the nozzle at a given time as compared to a nozzle outlet having a relatively larger cross-sectional area. However, opportunities to increase performance of the engine can be limited by the amount of exhaust gases flowing through nozzles having static or non-adjustable profiles.

Disclosed herein are example exhaust systems including adjustable nozzles to control emission of exhaust gases from an engine in view of an infrared signature of a vehicle including the engine. Example exhaust systems disclosed herein include a variable exhaust area nozzle and an exit area to receive exhaust gases emitted by the nozzle. At least a portion of the nozzle including the outlet is disposed in (e.g., surrounded by) the exit area. Opening(s) are defined between the portion of the nozzle disposed in the exit area and a portion of the exit area. Ambient air enters the exit area via the opening(s) and mixes with the exhaust gases to reduce a temperature of the exhaust gases. In examples in which the vehicle is in, for instance, a threatening environment, an angle of convergence of the nozzle can be adjusted to decrease a size of the portion of the nozzle including the nozzle outlet (i.e., the nozzle outlet is narrowed). As a result, a size of the ambient air openings defined between the exit area and the portion of the nozzle disposed in the exit area increases, which permits more ambient air to enter the exit area. The increased flow of ambient air into the exit area further reduces the temperature of the exhaust gases and surrounding vehicle surface temperatures, which can reduce the infrared signature of the vehicle.

Example exhaust systems disclosed herein can also affect performance of the engine(s) of the vehicle. For instance, when the vehicle is in a non-threatening environment, the angle of convergence of the nozzle can be adjusted to increase a size of the portion of the nozzle including the nozzle outlet (i.e., the nozzle outlet is widened). As a result, an increased amount of exhaust gases can exit the nozzle and be expelled via the exit area. Also, a size of the ambient air opening(s) is decreased due to the increased size of the portion of the nozzle disposed in the exit area. As a result, less ambient air enters the exit area, which provides for less cooling of the exhaust gases. Also, the larger nozzle outlet reduces engine backpressure (e.g., pressure buildup or forces acting on the exhaust gases moving through the nozzle). Thus, increasing the nozzle size can provide for, for example, improved engine fuel burn and power. As such, examples disclosed herein can be used to selectively affect engine performance in view of an infrared signature of the vehicle.

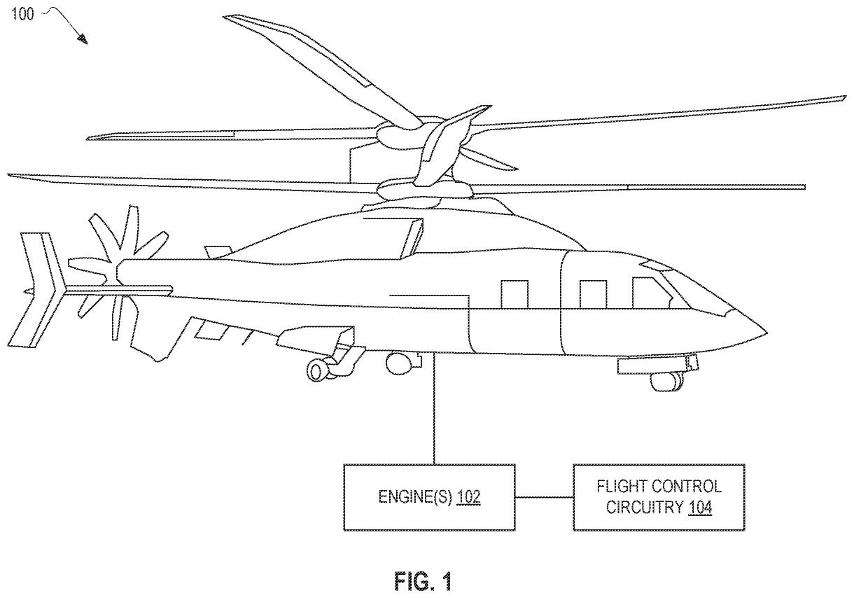

FIG. 1 illustrates an example air vehicle 100 in which examples disclosed herein may be implemented. The air vehicle 100 includes one or more engines 102. In the example of FIG. 1, the engine(s) 102 are gas turbine engine(s). Exhaust gases generated by the engine(s) 102 provide power to propel the aircraft 100 forward or hover in place. The example air vehicle 100 includes flight control circuitry 104 to generate instructions to control operation of the air vehicle 100, including the engines 102. Although the example air vehicle 100 of FIG. 1 is illustrated as a manned air vehicle, examples disclosed herein can also be implemented in unmanned air vehicles. Also, although examples disclosed herein are discussed in connection with air vehicles, examples disclosed herein could be used in connection with other types of vehicles to control emission of exhaust gases.

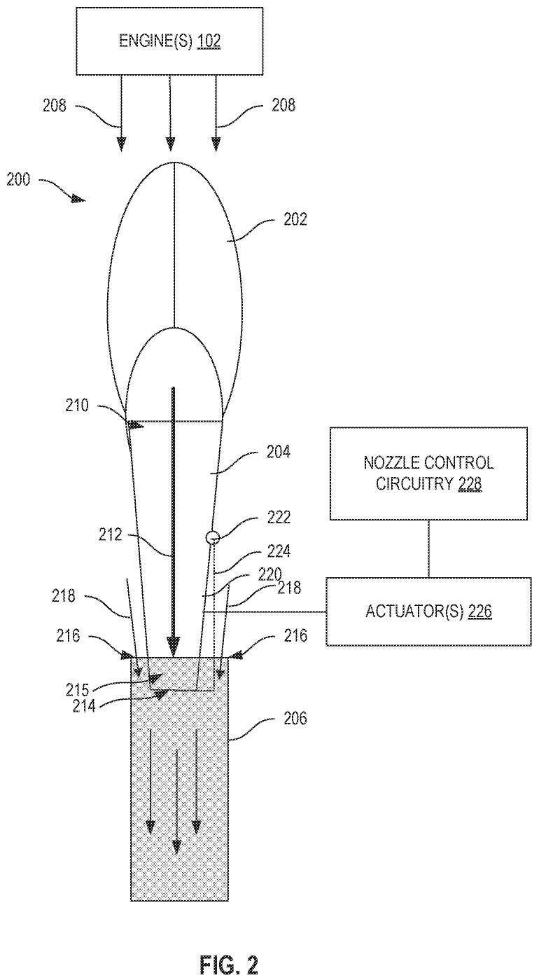

FIG. 2 illustrates an example exhaust system 200 of the example air vehicle 100 of FIG. 1 to expel exhaust gases generated by one or more of the engines 102 of the air vehicle 100. FIG. 2 illustrates a top view of the exhaust system 200. The example exhaust system 200 of FIG. 2 includes a manifold 202 fluidly coupled to a nozzle 204. The nozzle 204 is fluidly coupled to an exit area 206 (e.g., a plenum) of the exhaust system 200. The manifold 202, the nozzle 204, and/or the exit area 206 can be supported by, for instance, one or more portions of the air vehicle 100 of FIG. 1 (e.g., a frame of the air vehicle 100). Also, the manifold 202, the nozzle 204, and/or the exit area 206 can have different sizes and/or shapes than the examples shown in FIG. 2. The air vehicle 100 of FIG. 1 can include one or more exhaust systems 200 based on, for instance, a number of engines 102 of the air vehicle 100.

Exhaust gases from the engine(s) 102 flow into the manifold 202, as represented by arrows 208 in FIG. 2. The gases flow from the manifold 202 into a first end or inlet 210 of the nozzle 204, as represented by arrow 212 in FIG. 2. The nozzle 204 directs the exhaust flow into the exit area 206 of the exhaust system 200 via a second end or outlet 214 of the nozzle 204. In the example of FIG. 2, a portion 215 of the nozzle 204 including the outlet 214 is at least partially disposed in the exit area 206 (e.g., at least partially surrounded by a wall defining the exit area 206). As illustrated in FIG. 2, the nozzle 204 converges or narrows between the inlet 210 and the outlet 214 to accelerate the flow of exhaust gases and generate propulsive thrust. The angle of convergence of the nozzle 204 can differ from the example shown in FIG. 2.

In the example of FIG. 2, ambient air from an environment in which the aircraft 100 is located flows into the exit area 206 to mix with the exhaust gases flowing into the exit area 206 via the nozzle 204. One or more openings 216 are defined between the exit area 206 and the portion 215 of the nozzle 204 disposed in the exit area 206 to enable ambient air to enter the exit area 206. For instance, the opening(s) 216 can be defined between an inner surface of the exit area 206 and an outer surface of the portion of the nozzle 204 disposed in the exit area 206. In particular, ambient air is drawn into the exit area 206 based on an ejector effect. For instance, a velocity of the exhaust gases is increased by the convergence profile of the nozzle 204 and is highest proximate to the outlet 214 of the nozzle 204. A low pressure region is created in the exit area 206 proximate to the outlet 214 of the nozzle 204 due to the increased velocity of the exhaust gases flowing from the nozzle 204. Ambient air is pulled or entrained into the body of the exit area 206 via the opening(s) 216 as represented by arrows 218 of FIG. 2. The ambient air mixes with the exhaust gases from the nozzle 204 to reduce a temperature of the exhaust gases. The reduced temperature of the exhaust gases reduces an infrared signature of the air vehicle 100 and, thus, the detectability of the aircraft 100 via infrared sensors.

In the example of FIG. 2, one or more portions of the nozzle 204 can move (e.g., pivot, slide) to adjust or vary the angle of convergence of the nozzle 204. In this example, the adjustable portion(s) of the nozzle 204 defines at least some of the nozzle portion 215 including the outlet 214. Thus, a size (e.g., a width, a diameter, a cross-sectional area) of the outlet 214 of the nozzle 204 can change based on adjustment of the convergence profile of the nozzle 204. For instance, in the example of FIG. 2, a wall portion or plate 220 (e.g., a sidewall portion) of the nozzle 204 can move about a pivot 222 (e.g., a shaft, a pin) to increase or decrease the angle of convergence of the portion 215 of the nozzle 204, as represented by the dashed line 224 in FIG. 2. Thus, an area of the nozzle 204 through which the exhaust gases flow into the exit area 206 varies or changes based on the size of the outlet 214. The variable area exhaust nozzle 204 of FIG. 2 can include one or more moveable plates 220 to adjust the size (e.g., a cross-sectional area, a width) of at least a portion of the nozzle 204.

Also, a size (e.g., a cross-sectional area, a width) of the opening(s) 216 defined between the nozzle 204 and the exit area 206 varies based on the adjustments to the angle of convergence of the portion 215 of the nozzle 204. In particular, when the movable plates(s) 220 of the nozzle 204 are adjusted such that the angle of convergence of the nozzle portion 215 is decreased, the size of the outlet 214 is increased relative to the example shown in FIG. 2, and the size of the opening(s) 216 is decreased due to the increased footprint (e.g., width) of the portion 215 of the nozzle 204 relative to the exit area 206. Put another way, when the size of nozzle portion 215 (and the outlet 214) is increased, there is less space defined between the inner surface of the exit area 206 and the outer surface of the portion 215 of the nozzle 204 disposed in the exit area 206. Conversely, when the moveable plate(s) 220 of the nozzle 204 are adjusted such that the angle of convergence of the nozzle portion 215 is increased, the size of the outlet 214 is decreased relative to the example shown in FIG. 2, and the size of the opening(s) 216 is increased due to the smaller footprint (e.g., width) of the portion 215 of the nozzle 204 relative to the exit area 206. As disclosed herein, the moveable plate(s) 220 of the nozzle 204 can be actuated to cause the size of the opening(s) 216 to be adjusted to affect an infrared signature of the air vehicle 100.

The exhaust system 200 of FIG. 2 includes one or more actuators 226 to cause the plate(s) 220 of the nozzle 204 to move (e.g., pivot, slide). The actuator(s) 226 can include, for example, linear actuator(s), pneumatic actuator(s), hydraulic actuator(s), etc. Although FIG. 2 shows one pivot 222, the nozzle 204 can include additional pivots about which other portions or plates 220 of the nozzle 204 can move (e.g., a second pivot point located at an opposing side of the nozzle 204 from the pivot 222 shown in FIG. 2).

In the example of FIG. 2, nozzle control circuitry 228 (e.g., processor circuitry) outputs instructions for the actuator(s) 226 to control movement of the plate(s) 220 and, thus, a size of the portion 215 of the nozzle 204 including the outlet 214 through which the exhaust gases are expelled. Based on the instructions from the nozzle control circuitry 228, the actuator(s) 226 cause the plate(s) 220 of the nozzle 204 to move to adjust a convergence profile of the nozzle 204 and, thus, to increase or decrease a size of the portion 215 of the nozzle 204. The nozzle control circuitry 228 can be in communication with the flight control circuitry 104 (FIG. 1) of the air vehicle 100 and can respond to inputs from, for instance, a pilot of the air vehicle 100. In examples disclosed herein, the nozzle control circuitry 228 controls the actuator(s) 226 and, thus, a convergence profile of at least a portion of the nozzle 204 to affect performance of the engine 102 in view of an infrared signature associated with the exhaust gases output by the engine 102.

For example, when the air vehicle 100 is flying in a non-threating environment, the nozzle control circuitry 228 can output instructions (e.g., in response to user input(s)) to cause the plate(s) 220 to move to reduce an angle of convergence of at least the portion 215 of the nozzle 204. Put another way, the plate(s) 220 move to increase a size (e.g., width, cross-sectional area) of the portion 215 of the nozzle 204 and, thus, a size of the outlet 214. The increased size of the outlet 214 of the nozzle 204 permits a larger amount of exhaust gases to be expelled and reduces engine backpressure (e.g., pressure buildup or forces acting on the exhaust gases moving through the nozzle), which can provide for improved power and fuel burn of the engine(s) 102 of the air vehicle 100 during, for instance, long range flights.

As result of the increased size of the portion 215 of the nozzle 204, a size of the opening(s) 216 defined between the nozzle portion 215 and the exit area 206 is reduced. Thus, less ambient air enters into the exit area 206 as compared to when the size (e.g., width, cross-sectional area) of the nozzle portion 215 is narrower. The reduction in ambient air entering the exit area 206 results in less cooling of the exhaust gases flowing into the exit area 206 from the nozzle 204. As such, the infrared signature of air vehicle 100 due to the emission of the exhaust gases may increase (e.g., the air vehicle may be more detectable via infrared sensors).

In examples in which, for instance, the air vehicle 100 is flying through a threatening environment, the nozzle control circuitry 228 can output instructions (e.g., in response to user input(s)) to cause the plate(s) 220 to move to increase the angle of convergence of at least the portion 215 of the nozzle 204. Put another way, the plate(s) 220 move to decrease a size (e.g., width) of the portion 215 of the nozzle 204 and, thus, a size of the outlet 214. Decreasing the size of the nozzle outlet 214 increases a size of the opening(s) 216 defined between the nozzle portion 215 and the exit area 206. As such, an increased amount of ambient air can enter the exit area 206 as compared to when the size of the nozzle portion 215 is decreased (i.e., when the angle of convergence of the nozzle 204 is increased). The ambient air mixes with the exhaust gases in the exit area 206 and reduces a temperature of the exhaust gases. As a result, the infrared signature associated with the air vehicle 100 due to the emission of exhaust gases can be reduced (e.g., the air vehicle may be less detectable via infrared sensors). The decreased size of the outlet 214 of the nozzle 204 permits less exhaust gases to be emitted via the outlet 214 and, thus, can affect performance of the engine 102 by, for example, reducing power generated. Thus, the nozzle control circuitry 228 can selectively adjust the size of the nozzle outlet 214 in view of considerations such as engine performance and detectability of the air vehicle 100 when in threatening areas.

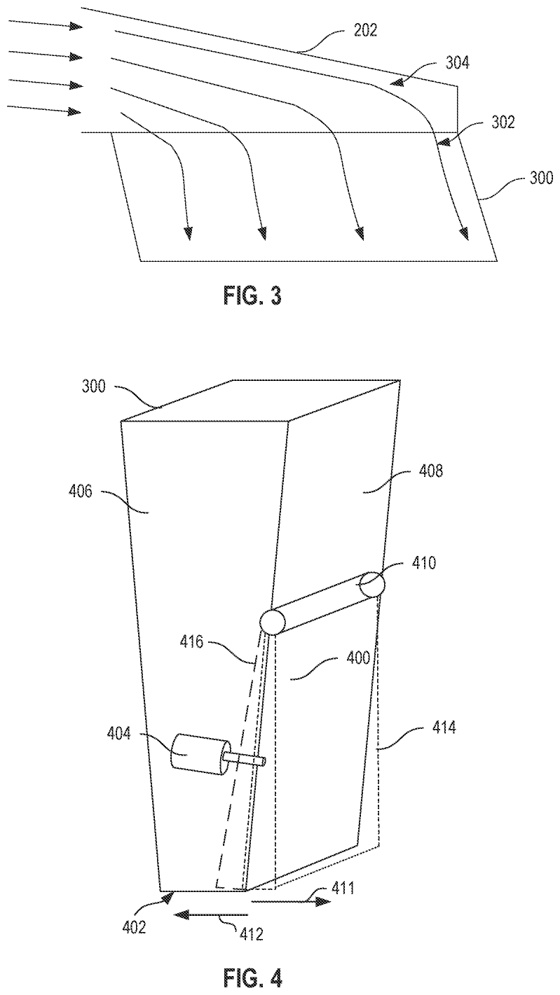

FIG. 3 is a side view of the manifold 202 of FIG. 2 and an example variable area exhaust nozzle 300 (e.g., the nozzle 204 of FIG. 2) that may be used with the example exhaust system 200 of FIG. 2. As shown in FIG. 3, an inlet 302 of the nozzle 300 is disposed relative to the manifold 202 such that a flow path 304 defined by the manifold 202 and the nozzle 300 causes the flow of the exhaust gases to turn relative to the direction of flow of the gases entering the manifold 202. The turning of the flow path 304 can affect (e.g., reduce) the infrared signature of the exhaust by creating line-of-sight blockage(s) with respect to viewing surface(s) (e.g., the hottest surfaces) of the engine(s) 102 and engine exhaust. For instance, the turning of the flow path 304 reduces a range of angles through which a direct line-of-sight of the engine(s) 102 can be obtained with respect to viewing the (e.g., hottest) surfaces of the engine(s) 102 and engine exhaust.

FIG. 4 is a perspective view of the example nozzle 300 of FIG. 3 including a moveable plate 400 (e.g., the plate 220 of FIG. 2). For illustrative purposes, the manifold 202 and the exit area 206 of FIGS. 2 and/or 3 are not shown in FIG. 4. As illustrated in FIG. 4, the plate 400 defines at least a portion of an outlet 402 of the nozzle 300. At least a portion of the nozzle 300 including the outlet 402 is disposed in (e.g., surrounded by) the exit area 206 of the exhaust system 200 as disclosed in connection with FIG. 2. A size and/or shape of the nozzle 300 and/or the plate 400 can differ from the example shown in FIG. 4.

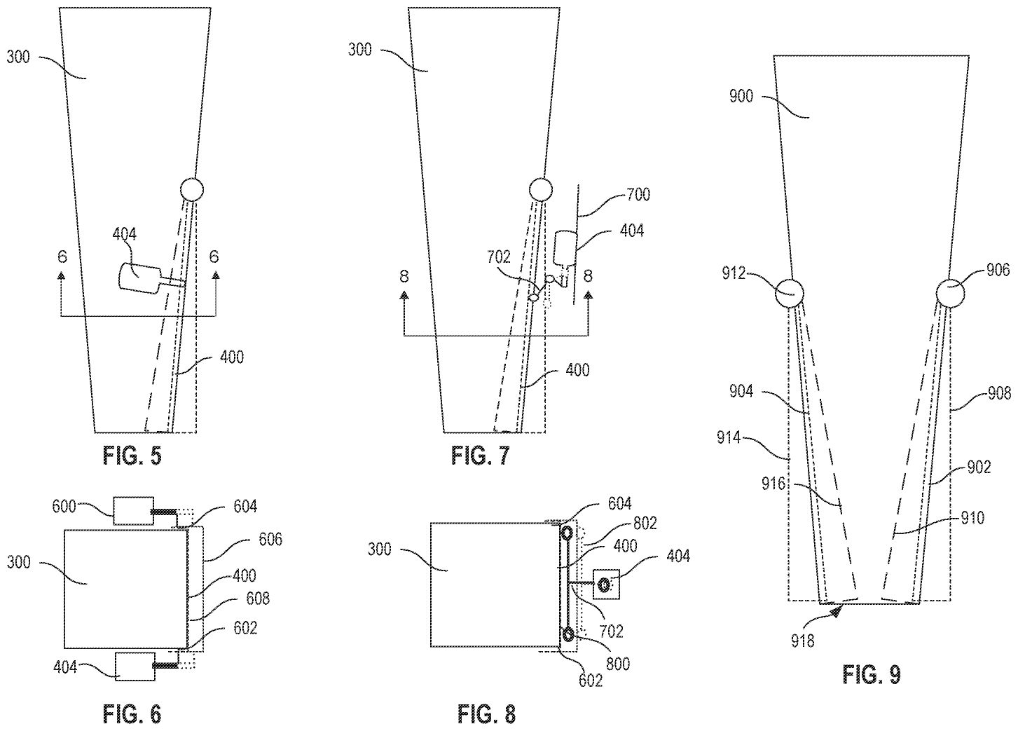

In the example of FIG. 3, the plate 400 is disposed in a first (e.g., default) position. The first (e.g., default) position can be defined based on, for example, user input(s). An actuator 404 is operatively coupled to the plate 400. In the example of FIG. 4, the actuator 404 can be supported by (e.g., coupled to) a portion of the nozzle 300 such as wall or surface 406 of the nozzle 300. Although in the example of FIG. 4 shows one actuator 404, one or more other actuators 404 could be supported by the nozzle 300 to move the plate 400, as disclosed in connection with FIGS. 5 and 6.

The plate 400 is pivotable relative to a remaining portion of the nozzle 300. For instance, the plate 400 is pivotably coupled (e.g., hingedly coupled) to a surface 408 of the nozzle 300 such that the plate 400 moves relative to the surface 408 via a pivot 410 (e.g., shaft, pin). In some examples, the surfaces 406, 408 of the nozzle 300 are integral surfaces. The pivot 410 defines an axis about which the plate 400 moves. The location of the pivot 410 and/or the actuator 404 can differ from the example shown in FIG. 4. In some examples, a location of the coupling of the actuator 404 to the plate 400 relative to the pivot 410 can be selected in view of moment forces (e.g., to minimize or reduce moment forces). In some examples, one or more portions of the plate 400 and/or the surface(s) 406, 408 include coatings to reduce friction between portions of the nozzle 300 during movement of the plate 400. The coatings can include, for instance, polytetrafluoroethylene (PTFE), a nitride coating, a nickel plating, an inconel coating, etc.

As represented by arrows 411, 412 of FIG. 4, the plate 400 can move (e.g., slide) about the pivot 410 to change an angle of convergence of a portion of the nozzle 300 including the outlet 402. In particular, the actuator(s) 404 can cause the plate 400 to move from the first position of FIG. 4 in a direction represented by the arrow 411 of FIG. 4 to a second position as represented by dashed line 414 in FIG. 4. When the plate 400 is moved to the second position, the angle of convergence of the portion of the nozzle 300 including the outlet 402 decreases and, thus, a size of an outlet 402 increases. As disclosed in connection with FIG. 2, increasing the size of the nozzle outlet 402 increases the amount of exhaust gases that are expelled by the exhaust system 200 of FIG. 2.

The actuator(s) 404 can cause the plate 400 to move in an opposing direction as represented by the arrow 412 of FIG. 4 from the first position to a third position as represented by dashed line 416 in FIG. 4. When the plate 400 is in the third position, the angle of convergence of the portion of the nozzle 300 including the outlet 402 is increased (i.e., the nozzle 300 is narrower than when the plate 400 is in the first position and the second position). Thus, the size of the outlet 402 is decreased. As disclosed in connection with FIG. 2, decreasing the size of the nozzle outlet 402 increases the size of the opening(s) 216 (FIG. 2) defined by the portion of the nozzle 300 disposed in the exit area 206 (FIG. 2). As a result, more ambient air can enter the exit air to reduce a temperature of the exhaust gases that are expelled by the exhaust system 200 of FIG. 2 and, thus, the infrared signature of the air vehicle 100.

FIG. 5 is a side view of the example nozzle 300 of FIGS. 3 and 4 including the actuator 404. FIG. 6 is a cross-sectional view of the nozzle 300 taken along the 6-6 line of FIG. 5. As shown in FIG. 6, the actuator 404 is a first actuator and a second actuator 600 is supported by (e.g., coupled to) the nozzle 300. In the example of FIG. 6, the first actuator 404 is operatively coupled to a first end 602 of the plate 400 and the second actuator 600 is operatively coupled to a second end 604 of the plate 400 opposite the first end 602. The nozzle control circuitry 228 can output instructions to cause the actuators 404, 600 to move the plate 400 simultaneously or substantially simultaneously to reduce torquing or skewing of the plate 400 during movement of the plate 400 as represented by dashed lines 606, 608 of FIG. 6. The actuators 404, 600 can be operatively coupled to other portions of the plate 400 than shown in FIGS. 5 and 6.

FIG. 7 is a side view of the example nozzle 300 of FIG. 3 in which the actuator 404 is supported by a portion of the air vehicle 100 other than the nozzle 300 or, more generally, the exhaust system 200. In the example of FIG. 7, the actuator 404 can be carried by, for instance, a frame of the air vehicle 100 as represented by line 700 in FIG. 7. In some examples, an arm 702 extends between the actuator 404 and the plate 400 of the nozzle 300 to transfer forces from the actuator 404 to the plate 400 to cause the plate 400 to move.

FIG. 8 is a cross-sectional view of the nozzle 300 of FIG. 7 taken along the 8-8 line of FIG. 7. As shown in FIG. 8, the arm 702 is coupled to the first end 602 and the second end 604 of the plate 400. The coupling of the arm 702 to the first end 602 and the second end 604 can reduce skew of the plate 400 during movement of the plate 400 as represented by dashed lines 800, 802 of FIG. 8. However, the arm 702 could be coupled to other portion(s) of the plate 400 than shown in FIGS. 7 and 8.

Although the example nozzles 204, 300 of FIGS. 2-8 include one moveable portion (e.g., the plate 220, 400), the nozzle of the example exhaust system 200 of FIG. 2 can include other moveable portions. FIG. 9 illustrates an example variable area exhaust nozzle 900 including a first plate 902 pivotably coupled to a first portion of the nozzle 900 and a second plate 904 pivotably coupled to a second portion of the nozzle 900. The first plate 902 can move relative to a first pivot 906 as represented by dashed lines 908, 910 of FIG. 9. The second plate 904 can move relative to a second pivot 912 as represented by dashed lines 914, 916 of FIG. 9. Thus, in the example of FIG. 9, the nozzle control circuitry 228 of FIG. 2 can control movement of one or more of the plates 902, 904 to adjust the convergence profile of the nozzle 900 and, thus, a size of an outlet 918 of the nozzle 900 and a size of the ambient air opening(s) 216 of FIG. 2. In some examples, the first plate 902 and the second plate 904 are separately moveable via respective actuators (e.g., the actuators 226, 404, 600). In some examples, one actuator is operatively coupled to the first plate 902 and the second plate 904 to jointly control the movement of the plates 902, 904.

A size and/or shape of the nozzle 900 and/or the plates 902, 904 can differ from the example shown in FIG. 9. Also, the location of the pivots 906, 912 can differ from the example shown in FIG. 9. Although in the example of FIG. 9, the second plate 904 is spaced apart from (e.g., opposite) the first plate 902, a location of the second plate 904 relative to the first plate 902 can differ from the example shown in FIG. 9 (e.g., the second plate 904 can be adjacent (i.e., directly adjacent) the first plate 902).

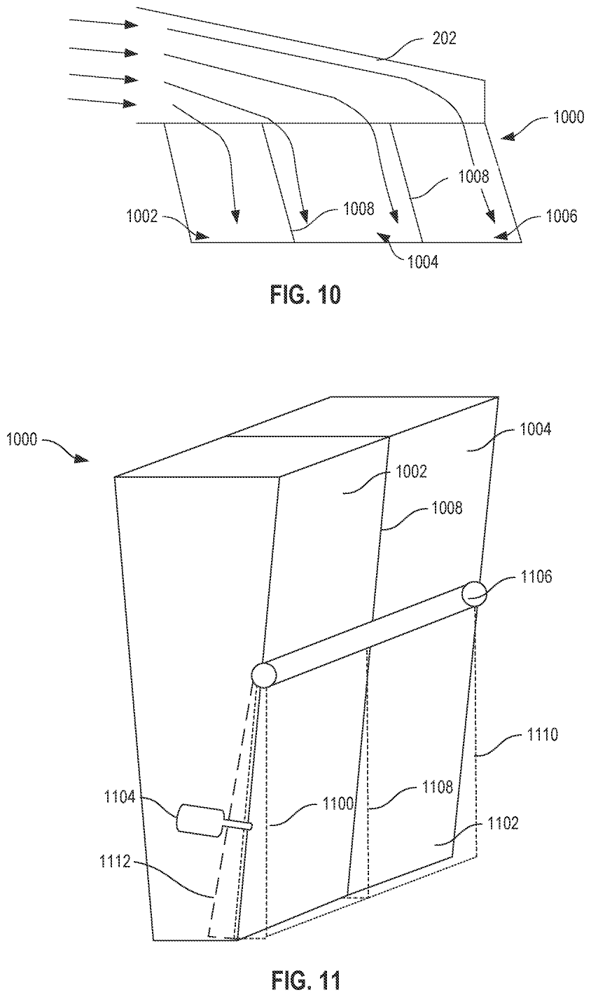

FIG. 10 is a side view of the manifold 202 of FIG. 2 and another example variable area exhaust nozzle 1000 (e.g., the nozzle 204 of FIG. 2) that may be used with the example exhaust system 200 of FIG. 2. In the example of FIG. 10, the nozzle 1000 include a first nozzle 1002, a second nozzle 1004, and a third nozzle 1006. Each of the nozzles 1002, 1004, 1006 defines a flow path for the exhaust gases exiting the manifold 202.

In some examples, ribs 1008 (e.g., plates, walls) divide or separate an area defining the nozzle 1000 into the respective first, second, and third nozzles 1002, 1004, 1006. The ribs 1008 can provide line-of-sight blockage(s) to the hot engine(s) 102 and exhaust surfaces, in addition to facilitating turning of the flow. The rib(s) 1008 can be separately inserted and coupled to one or more portions (e.g., sidewall(s)) of the nozzle 1000 to define the first, second, and third nozzles 1002, 1004, 1006. In other examples, the rib(s) 1008 are integrally formed in the nozzle 1000. In other examples, one or more of the nozzles 1002, 1004, 1006 is separately formed and coupled to another one of the nozzles 1002, 1004, 1006 via mechanical or chemical fasteners. The example of FIG. 10 can include additional or fewer nozzles 1002, 1004, 1006 (e.g., two nozzles; four nozzles, five nozzles, six nozzles). As disclosed herein, a convergence profile of one or more of the nozzles 1002, 1004, 1006 can be adjusted to provide for variable exhaust emissions to affect engine performance and an infrared signature of the air vehicle 100.

FIG. 11 is a perspective view of a portion of the example nozzle 1000 of FIG. 10 showing the first nozzle 1002 and the second nozzle 1004. As shown in FIG. 11, the first nozzle 1002 includes a moveable plate 1100. Also, the second nozzle 1004 includes a movable plate 1102. The plates 1100, 1102 can be actuated to move to adjust a convergence profile of the nozzles 1002, 1004 substantially as disclosed in connection with FIGS. 2-9. For instance, one or more actuators 1104 can cause the plates 1100, 1102 to move about a common pivot 1106 as represented by dashed lines 1108, 1110, 1112 and substantially as disclosed in connection with FIGS. 2-9. In some examples, the plates 1100, 1102 are independently moveable about the pivot 1106 via respective actuators 1104. In some examples, one actuator 1104 causes each of the plates 1100, 1102 to pivot. In some examples, the plates 1100, 1102 at least partially overlap such that movement of one of the plates 1100 causes the other plate 1102 to move. In some examples, the plates 1100, 1102 include cutouts to accommodate the rib 1008 disposed between the first nozzle 1002 and the second nozzle 1004.

In some examples, the first plate 1100 and the second plate 1102 are portions of a single plate that is pivotably coupled to and extends across the first nozzle 1002 and the second nozzle 1004. The third nozzle 1006 of FIG. 10 can include a respective moveable plate or a portion of a plate extending across the nozzles 1002, 1004, 1006 that is the same or substantially the same as the plates 1100, 1102 of the first and second nozzles 1002, 1004 and moves about the pivot 1106. A size and/or shape of the nozzles 1000, 1002, 1004, 1006 and/or the plates 1100, 1102 can differ from the examples shown in FIGS. 10 and 11.

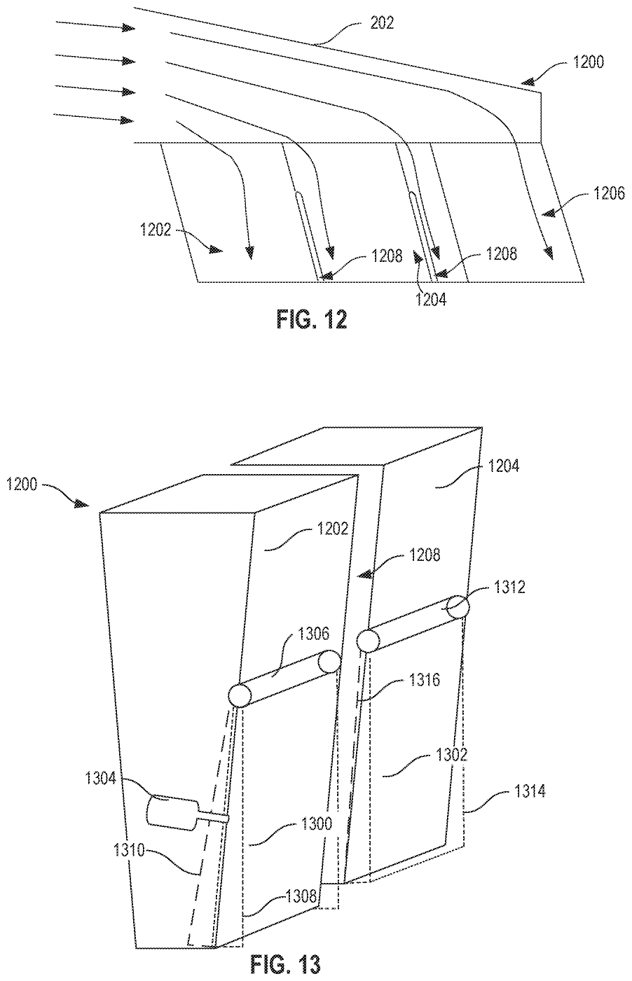

FIG. 12 is a side view of the manifold 202 of FIG. 2 and another example variable area exhaust nozzle 1200 (e.g., the nozzle 204 of FIG. 2) that may be used with the example exhaust system 200 of FIG. 2. In the example of FIG. 12, the nozzle 1200 includes a first nozzle 1202, a second nozzle 1204, and a third nozzle 1206. Each of the nozzles 1002, 1004, 1006 defines a flow path for the exhaust gases exiting the manifold 202. In the example of FIG. 12, at least a portion of a respective one of the nozzles 1202, 1204, 1206 is spaced apart from a portion of another one of the nozzles 1202, 1204, 1206 by an opening or slot 1208 defined between two of the nozzles 1202, 1204, 1206. The slot(s) 1208 can enable ribs to be placed in the downstream exit area 206 (e.g., a plenum) that overlaps with the end of the nozzle 1200, allowing for the exit area 206 to provide for line-of-sight blockage(s).

FIG. 13 is a perspective view of a portion of the example nozzle 1200 of FIG. 12 showing the first nozzle 1202 and the second nozzle 1204. As shown in FIG. 13, the first nozzle 1202 includes a moveable plate 1300. Also, the second nozzle 1204 includes a movable plate 1302. The plates 1300, 1302 can be actuated to move to adjust a convergence profile of the nozzles 1202, 1204 substantially as disclosed in connection with FIGS. 2-12. For instance, one or more actuators 1304 can cause the first plate 1300 to move about a pivot 1306 as represented by dashed lines 1308, 1310 of FIG. 13 and substantially as disclosed in connection with FIGS. 2-9. One or more other actuators (not shown) can cause the second plate 1302 to pivot about a pivot 1312 as represented by dashed lines 1314, 1316 of FIG. 13. In some examples, the axes defined by the pivots 1306, 1312 are substantially aligned. In some examples, the plates 1300, 1302 are hingedly coupled to a pivot that extends across the first and second nozzles 1202, 1204, where the two plates 1300, 1302 may be spaced apart along the pivot to accommodate the slot 1208.

The third nozzle 1206 of FIG. 12 can include a respective moveable plate that is the same or substantially the same as the plates 1300, 1302 of the first and second nozzles 1202, 1204. A size and/or shape of the nozzles 1200, 1202, 1204, 1206 and/or the plates 1300, 1302 can differ from the examples shown in FIGS. 12 and 13.

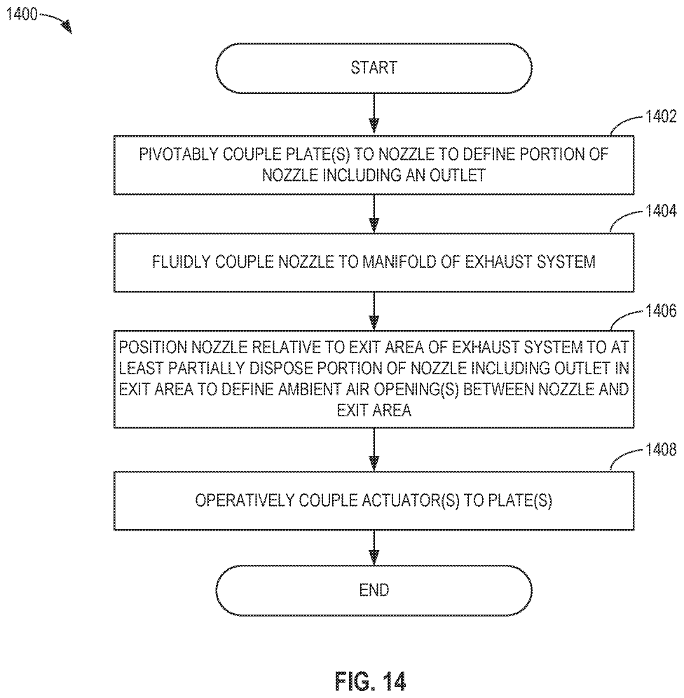

FIG. 14 is a flowchart of an example method 1400 for assembling an exhaust system including a variable exhaust area nozzle to affect engine performance and/or an infrared signature of an air vehicle in accordance with teachings of this disclosure. At block 1402, the example method 1400 includes pivotably coupling plate(s) or wall portion(s) to a nozzle to define a portion of the nozzle including an outlet. For example, one or more plate(s) 220, 400, 902, 904, 1100, 1102, 1300, 1302 can be coupled to surface(s) 406, 408 of the nozzle(s) 204, 300, 900, 1000, 1002, 1004, 1006, 1200, 1202, 1204, 1206 of FIGS. 2-13 via a pivot 222, 410, 906, 912, 1106, 1306, 1312, where the plate(s) 220, 400, 902, 904, 1100, 1102, 1300, 1302 define a portion of the nozzle(s) 204, 300, 900, 1000, 1002, 1004, 1006, 1200, 1202, 1204, 1206 including the outlet 214, 402, 918.

At block 1404, the example method 1400 includes fluidly coupling an inlet of the nozzle to a manifold of the exhaust system. For example, the inlet 210, 302 of the nozzle(s) 204, 300, 900, 1000, 1002, 1004, 1006, 1200, 1202, 1204, 1206 can be fluidly coupled to the manifold 202 to define a flow path for exhaust gases emitted by the engine(s) 102 of the air vehicle 100.

At block 1406, the example method 1400 includes positioning the nozzle relative to the exit area of the exhaust system to at least partially dispose a portion of the nozzle including the outlet in the exit area to define opening(s) between the nozzle and the exit area for ambient air to enter the exit area. For example, the nozzle(s) 204, 300, 900, 1000, 1002, 1004, 1006, 1200, 1202, 1204, 1206 can be positioned relative to the exit area 206 such that the portion 215 of the nozzle(s) 204, 300, 900, 1000, 1002, 1004, 1006, 1200, 1202, 1204, 1206 including the outlet 214, 402, 918 is at least partially disposed in (e.g., surrounded by) the exit area 206. The ambient air opening(s) 216 can be defined between an interior surface of the exit area 206 and an exterior surface of the portion 215 of the nozzle(s) 204, 300, 900, 1000, 1002, 1004, 1006, 1200, 1202, 1204, 1206 disposed in the exit area 206.

At block 1408, the example method 1400 includes operatively coupling one or more actuators to the plate(s) of the nozzle. For example, the actuator(s) 226, 404, 600, 1104, 1304 can be supported by (e.g., carried by, coupled to) a surface 406 of the nozzle(s) 204, 300, 900, 1000, 1002, 1004, 1006, 1200, 1202, 1204, 1206. In some examples, the actuator(s) 226, 404, 600, 1104, 1304 are carried by a frame of the air vehicle 100 and operatively coupled to the plate(s) 220, 400, 902, 904, 1100, 1102, 1300, 1302 via an arm 702.

Although the example method 1400 is described with reference to the flowchart illustrated in FIG. 14, many other methods of assembling an exhaust system may alternatively be used. For example, the order of execution of the blocks may be changed, and/or some of the blocks described may be changed, eliminated, or combined. Similarly, additional operations may be included in the example method of FIG. 14 before, in between, or after the blocks shown in FIG. 14.

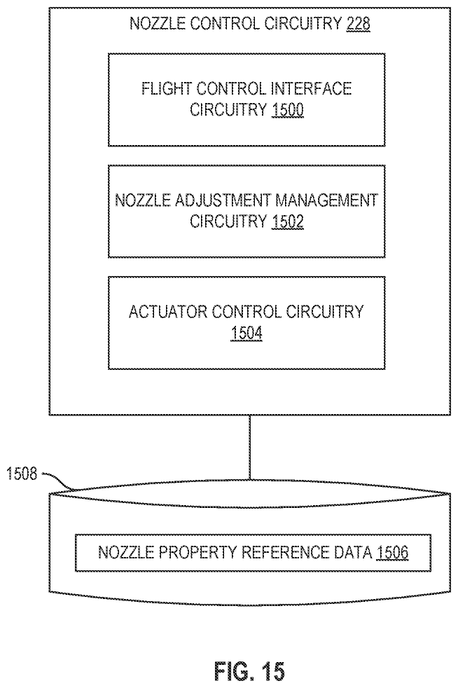

FIG. 15 is a block diagram of the example nozzle control circuitry 228 of FIG. 2 to cause the actuator(s) 226, 404, 600, 1104, 1304 to move the plate(s) 220, 400, 902, 904, 1100, 1102, 1300, 1302 of the example nozzle(s) 204, 300, 900, 1000, 1002, 1004, 1006, 1200, 1202, 1204, 1206 of FIGS. 2-13 to affect performance of the engine(s) 102 of the air vehicle 100 in view of an infrared signature of the air vehicle 100. The nozzle control circuitry 228 of FIG. 15 may be instantiated (e.g., creating an instance of, bring into being for any length of time, materialize, implement, etc.) by processor circuitry such as a central processing unit executing instructions. Additionally or alternatively, the nozzle control circuitry 228 of FIG. 15 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 15 may, thus, be instantiated at the same or different times. Some or all of the circuitry may be instantiated, for example, in one or more threads executing concurrently on hardware and/or in series on hardware. Moreover, in some examples, some or all of the circuitry of FIG. 15 may be implemented by microprocessor circuitry executing instructions to implement one or more virtual machines and/or containers.

The example nozzle control circuitry 228 of FIG. 15 includes flight control interface circuitry 1500, nozzle adjustment management circuitry 1502, and actuator control circuitry 1504.

The flight control interface circuitry 1500 receives instructions from the flight control circuitry 104 of FIG. 1 indicating that input(s) (e.g., user input(s), inputs(s) by the flight control circuitry 104) have been received with respect to adjusting the variable area exhaust nozzle(s) 204, 300, 900, 1000, 1002, 1004, 1006, 1200, 1202, 1204, 1206 of FIGS. 2-13. The instructions from the flight control circuitry 104 can indicate whether the nozzle(s) 204, 300, 900, 1000, 1002, 1004, 1006, 1200, 1202, 1204, 1206 should be adjusted to reduce the infrared signature of the air vehicle 100 or affect performance of the air vehicle 100 by increasing expulsion of exhaust gases generated by the engine(s) 102 of the air vehicle 100.

In response to the instructions from the flight control circuitry 104, the nozzle adjustment management circuitry 1502 determines adjustment(s) to the convergence profile of the nozzle(s) 204, 300, 900, 1000, 1002, 1004, 1006, 1200, 1202, 1204, 1206. For example, the nozzle adjustment management circuitry 1502 determines a size (e.g., width, cross-sectional area) of at least a portion 215 of the nozzle(s) 204, 300, 900, 1000, 1002, 1004, 1006, 1200, 1202, 1204, 1206 including the outlet 214, 402, 918 to either (a) reduce the infrared signature or (b) increase engine performance. The nozzle adjustment management circuitry 1502 can determines the adjustment(s) to the angle of convergence of the at least the portion 215 of the nozzle(s) 204, 300, 900, 1000, 1002, 1004, 1006, 1200, 1202, 1204, 1206 based on, for instance a current position of the movable nozzle plate(s) 220, 400, 902, 904, 1100, 1102, 1300, 1302 and nozzle property reference data 1506. The nozzle property reference data 1506 can include different angles of convergence and/or sizes (e.g., width, cross-sectional area) of at least a portion of a nozzle and corresponding effects on the exhaust gases expelled by the exhaust system 200 (e.g., amount of exhaust gases expelled, temperature of the exhaust gases).

For instance, to increase the amount of power and fuel burn by the engine(s) 102, the nozzle adjustment management circuitry 1502 determines a position to which the plate(s) 220, 400, 902, 904, 1100, 1102, 1300, 1302 should move from the current plate position to increase a size of the nozzle portion 215 including the outlet 214, 402, 918 based on the nozzle property reference data 1506. As a result of increasing the size (e.g., width) of the nozzle portion 215, the angle of convergence of the portion 215 of the nozzle(s) 204, 300, 900, 1000, 1002, 1004, 1006, 1200, 1202, 1204, 1206 is reduced (e.g., the nozzle portion 215 is widened). As a result of the decreased angle of convergence of the portion 215 of the nozzle(s) 204, 300, 900, 1000, 1002, 1004, 1006, 1200, 1202, 1204, 1206, a size of the ambient air opening(s) 216 is decreased and, thus, less ambient air enters the exit area 206. Also, more exhaust gases are expelled through the larger nozzle outlet 214, 402, 918, which can reduce engine backpressure and increase engine fuel burn and power.

Conversely, to reduce the infrared signature of the air vehicle 100, the nozzle adjustment management circuitry 1502 determines a position to which the plate(s) 220, 400, 902, 904, 1100, 1102, 1300, 1302 should move from the current plate position to decrease a size of the portion 215 of the nozzle(s) 204, 300, 900, 1000, 1002, 1004, 1006, 1200, 1202, 1204, 1206 based on the nozzle property reference data 1506. As a result, the angle of convergence of the portion 215 of the nozzle(s) 204, 300, 900, 1000, 1002, 1004, 1006, 1200, 1202, 1204, 1206 is increased (e.g., the nozzle portion 215 is narrowed). As a result of the increased angled of convergence of the portion 215 of the nozzle(s) 204, 300, 900, 1000, 1002, 1004, 1006, 1200, 1202, 1204, 1206, a size of the ambient air opening(s) 216 is increased and, thus, more ambient air enters the exit area 206 to reduce a temperature of the exhaust gases. Also, the size (e.g., width, cross-sectional area) of the nozzle outlet 214, 402, 918 is reduced, which reduces the amount of exhaust gases expelled.

The nozzle property reference data 1506 can be defined based on user input(s) and stored in a database 1508. In some examples, the nozzle control circuitry 228 includes the database 1508. In some examples, the database 1508 is located external to the nozzle control circuitry 228 in a location accessible to the nozzle control circuitry 228 as shown in FIG. 15.

The actuator control circuitry 1504 generates instructions to cause the actuator(s) 226, 404, 600, 1104 to move the plates(s) 220, 400, 902, 904, 1100, 1102, 1300, 1302 to the position determined by the nozzle adjustment management circuitry 1502 to adjust the convergence profile of the nozzle(s) 204, 300, 900, 1000, 1002, 1004, 1006, 1200, 1202, 1204, 1206. For example, the actuator control circuitry 1504 generates instructions to cause the actuator(s) 226, 404, 600, 1104 to move the plates(s) 220, 400, 902, 904, 1100, 1102, 1300, 1302 to increase or decrease a size (e.g., width) of at least the portion 215 of the nozzle(s) 204, 300, 900, 1000, 1002, 1004, 1006, 1200, 1202, 1204, 1206 including the outlet 214, 402, 918. The actuator control circuitry 1504 transmits the instructions to the actuator(s) 226, 404, 600, 1104.

While an example manner of implementing the nozzle control circuitry 228 of FIG. 2 is illustrated in FIG. 15, one or more of the elements, processes, and/or devices illustrated in FIG. 15 may be combined, divided, re-arranged, omitted, eliminated, and/or implemented in any other way. Further, the example flight control interface circuitry 1500, the example nozzle adjustment management circuitry 1502, the example actuator control circuit 1504, and/or, more generally, the example nozzle control circuitry 228 of FIG. 2, may be implemented by hardware alone or by hardware in combination with software and/or firmware. Thus, for example, any of the example flight control interface circuitry 1500, the example nozzle adjustment management circuitry 1502, the example actuator control circuit 1504, and/or, more generally, the example nozzle control circuitry 228 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example nozzle control circuitry 228 of FIG. 2 may include one or more elements, processes, and/or devices in addition to, or instead of, those illustrated in FIG. 15, and/or may include more than one of any or all of the illustrated elements, processes, and devices.

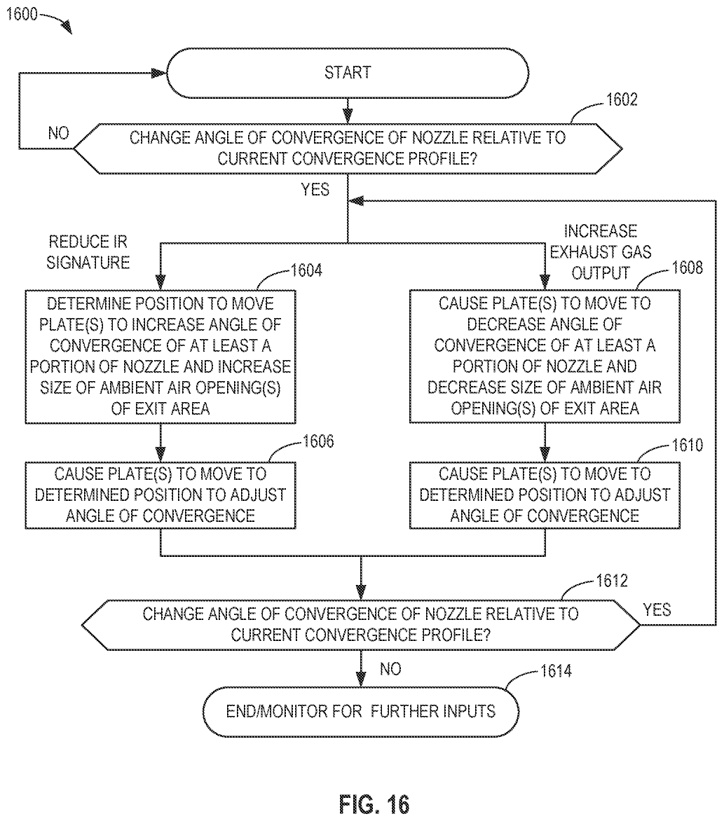

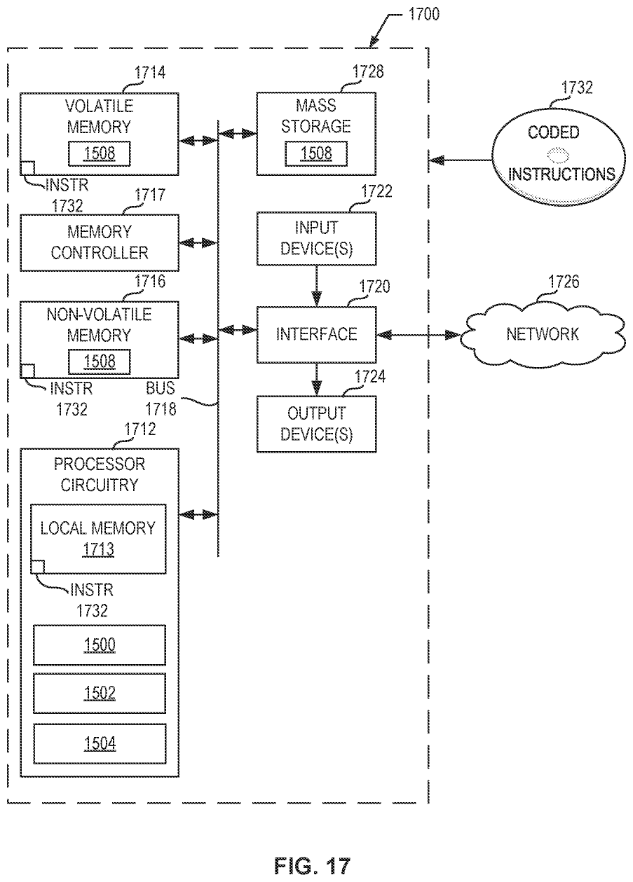

A flowchart representative of example machine readable instructions, which may be executed to configure processor circuitry to implement the nozzle control circuitry 228 of FIG. 15, is shown in FIG. 16. The machine readable instructions may be one or more executable programs or portion(s) of an executable program for execution by processor circuitry, such as the processor circuitry 1712 shown in the example processor platform 1700 discussed below in connection with FIG. 17. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 16, many other methods of implementing the example nozzle control circuitry 228 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 16 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 16 is a flowchart representative of example machine readable instructions and/or example operations 1600 that may be executed and/or instantiated by processor circuitry to adjust a nozzle of an exhaust system to affect performance of the engine(s) of an air vehicle in view of an infrared signature of the air vehicle. The machine readable instructions and/or the operations 1600 of FIG. 16 begin at block 1602, at which the flight control interface circuitry 1500 of the example nozzle control circuitry 228 of FIG. 15 determines if instructions (e.g., user input(s)) have been received from the flight control circuitry 104 of the air vehicle 100, wherein the instructions indicate that an angle of convergence of the nozzle(s) 204, 300, 900, 1000, 1002, 1004, 1006, 1200, 1202, 1204, 1206 should be adjusted to affect engine performance and/or the infrared signature of the air vehicle 100.

In examples in which the instructions from the flight control circuitry 104 indicate that the convergence profile of the nozzle(s) 204, 300, 900, 1000, 1002, 1004, 1006, 1200, 1202, 1204, 1206 should be adjusted to reduce an infrared signature of the air vehicle 100, control proceeds to block 1604. At block 1604, the nozzle adjustment management circuitry 1502 determines a position to move the plate(s) 220, 400, 902, 904, 1100, 1102, 1300, 1302 to increase the angle of convergence of at least the portion 215 of the nozzle(s) 204, 300, 900, 1000, 1002, 1004, 1006, 1200, 1202, 1204, 1206 and, as result, increase a size of the ambient air opening(s) 216 of exit area 206 of the exhaust system 200. The increased size of the ambient air opening(s) 216 permits an increased amount of ambient air to enter the exit area 206 via the ejector effect. The ambient air mixes with the exhaust gases to reduce a temperature of the exhaust gases and, thus, the infrared signature of the air vehicle. Also, the size (e.g., width, cross-sectional area) of the nozzle outlet 214, 402, 918 is reduced, which reduces the amount of exhaust gases expelled. The nozzle adjustment management circuitry 1502 can determine the position to move the plate(s) 220, 400, 902, 904, 1100, 1102, 1300, 1302 based on, for instance, a current position of the plate(s) 220, 400, 902, 904, 1100, 1102, 1300, 1302 and the nozzle property reference data 1506. At block 1606, the actuator control circuitry 1504 causes the actuator(s) 226, 404, 600, 1104, 1304 to move the plate(s) 220, 400, 902, 904, 1100, 1102, 1300, 1302 to the determined position to adjust the angle of convergence.

In examples in which the instructions from the flight control circuitry 104 indicate that the convergence profile of the nozzle(s) 204, 300, 900, 1000, 1002, 1004, 1006, 1200, 1202, 1204, 1206 should be adjusted to increase the exhaust gases expelled by the exhaust system 200 to, for instance, adjust engine performance (e.g., increase power, increase fuel burn), control proceeds to block 1608. At block 1608, the nozzle adjustment management circuitry 1502 determines a position to move the plate(s) 220, 400, 902, 904, 1100, 1102, 1300, 1302 to decrease the angle of convergence of at least the portion 215 of the nozzle(s) 204, 300, 900, 1000, 1002, 1004, 1006, 1200, 1202, 1204, 1206 (e.g., widen the nozzle portion 251), In particular, the nozzle adjustment management circuitry 1502 determines a position to which to move the plate(s) 220, 400, 902, 904, 1100, 1102, 1300, 1302 to increase a size of the nozzle outlet 214, 402, 918 to increase an amount of exhaust gases expelled by the exhaust system 200 and reduce engine backpressure. As a result, the size of the ambient air opening(s) 216 of exit area 206 of the exhaust system 200 decreases. The reduced size of the ambient air opening(s) 216 reduces the amount of ambient air entering the exit area 206 via the ejector effect, which provides for less cooling of the exhaust gases. The nozzle adjustment management circuitry 1502 can determine the position to move the plate(s) 220, 400, 902, 904, 1100, 1102, 1300, 1302 based on, for instance, a current position of the plate(s) 220, 400, 902, 904, 1100, 1102, 1300, 1302 and the nozzle property reference data 1506. At block 1610, the actuator control circuitry 1504 causes the actuator(s) 226, 404, 600, 1104, 1304 to move the plate(s) 220, 400, 902, 904, 1100, 1102, 1300, 1302 to the determined position to adjust the angle of convergence.

At block 1612, the flight control interface circuitry 1500 determines if additional instructions have been received to adjust the nozzle(s) 204, 300, 900, 1000, 1002, 1004, 1006, 1200, 1202, 1204, 1206 to affect engine performance or infrared signature of the air vehicle 100. The example instructions 1600 end at block 1614 with continued monitoring for input(s) to adjust the nozzle(s) 204, 300, 900, 1000, 1002, 1004, 1006, 1200, 1202, 1204, 1206.

FIG. 17 is a block diagram of an example processor platform 1700 structured to execute and/or instantiate the machine readable instructions and/or the operations of FIG. 16 to implement the nozzle control circuitry 228 of FIG. 15. The processor platform 1700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 1700 of the illustrated example includes processor circuitry 1712. The processor circuitry 1712 of the illustrated example is hardware. For example, the processor circuitry 1712 can be implemented by one or more integrated circuits, logic circuits, FPGAs, microprocessors, CPUs, GPUs, DSPs, and/or microcontrollers from any desired family or manufacturer. The processor circuitry 1712 may be implemented by one or more semiconductor based (e.g., silicon based) devices. In this example, the processor circuitry 1712 implements the example flight control interface circuitry 1500, the example nozzle adjustment management circuitry 1502, and the example actuator control circuitry 1504.

The processor circuitry 1712 of the illustrated example includes a local memory 1713 (e.g., a cache, registers, etc.). The processor circuitry 1712 of the illustrated example is in communication with a main memory including a volatile memory 1714 and a non-volatile memory 1716 by a bus 1718. The volatile memory 1714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1716 may be implemented by flash memory and/or any other desired type of memory device. Access to the main memory 1714, 1716 of the illustrated example is controlled by a memory controller 1717.

The processor platform 1700 of the illustrated example also includes interface circuitry 1720. The interface circuitry 1720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1722 are connected to the interface circuitry 1720. The input device(s) 1722 permit(s) a user to enter data and/or commands into the processor circuitry 1712. The input device(s) 1722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1724 are also connected to the interface circuitry 1720 of the illustrated example. The output device(s) 1724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1720 of the illustrated example, thus, typically includes a graphics driver card, a graphics driver chip, and/or graphics processor circuitry such as a GPU.

The interface circuitry 1720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1700 of the illustrated example also includes one or more mass storage devices 1728 to store software and/or data. Examples of such mass storage devices 1728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1732, which may be implemented by the machine readable instructions of FIG. 16, may be stored in the mass storage device 1728, in the volatile memory 1714, in the non-volatile memory 1716, and/or on a removable non-transitory computer readable storage medium such as a CD or DVD.

From the foregoing, it will be appreciated that example systems, methods, apparatus, and articles of manufacture have been disclosed that provide for exhaust systems having variable area exhaust nozzles that can be selectively adjusted to affect engine performance and an infrared signature of a vehicle such as an aircraft. Examples disclosed herein include nozzles having moveable portion(s) (e.g., pivotable or slidable plates) to adjust an angle of convergence of the nozzle. In some instances, as a result of movement of the nozzle plate(s), a size (e.g., width, cross-sectional area) of an outlet of the nozzle is increased. The increased size of the nozzle outlet permits an increased an amount of exhaust gases expelled by the exhaust system, reduces engine backpressure, and, thus, increases power and fuel burn from the engine(s) of an air vehicle. In examples in which, for instance, the air vehicle is flying in a threatening area, the angle of convergence of the nozzle can be increased by moving the plate(s) to decrease a size (e.g., width, cross-sectional area) of the outlet. As a result of increasing the angle of convergence of the nozzle, a size of ambient air opening(s) defined between a portion of the nozzle and an exit area of the exhaust system is increased. The increased size of the ambient air opening(s) permits more ambient air to enter the exit area and mix with the exhaust gases to reduce a temperature of the exhaust gases and surrounding surfaces and, thus, the infrared signature of the air vehicle.

Example exhaust systems having adjustable nozzles and related methods are disclosed herein. Further examples and combinations thereof including the following:

Example 1 includes an exhaust system comprising a nozzle, a portion of the nozzle moveable to change an angle of convergence of the nozzle; and an exit area, the portion of the nozzle at least partially disposed in the exit area, an opening defined between the exit area and the portion of the nozzle disposed in the exit area, a size of the opening to change in response to movement of the portion of the nozzle.

Example 2 includes the exhaust system of example 1, wherein the portion of the nozzle at least partially defines an outlet of the nozzle, a size of the outlet to change in response to the movement of the portion of the nozzle.

Example 3 includes the exhaust system of examples 1 or 2, wherein the portion of the nozzle includes a plate pivotably coupled to a surface of the nozzle.

Example 4 includes the exhaust system of any of examples 1-3, further including an actuator operatively coupled to the portion of the nozzle, the actuator carried by the nozzle.

Example 5 includes the exhaust system of any of examples 1-4, further including a manifold, the manifold, the nozzle, and the exit area defining a flow path for exhaust gases from an engine of an air vehicle, ambient air to enter the exit area via the opening.

Example 6 includes the exhaust system of any of examples 1-5, wherein the nozzle is a first nozzle and further including a second nozzle, the second nozzle including a moveable portion.

Example 7 includes the exhaust system of any of examples 1-6, further including a rib disposed between the first nozzle and the second nozzle.

Example 8 includes the exhaust system of any of examples 1-7, further including a slot defined between the first nozzle and the second nozzle.

Example 9 includes an air vehicle comprising a manifold to receive exhaust gases from an engine of the air vehicle; a nozzle fluidly coupled to the manifold, a portion of the nozzle moveable to adjust a size of an outlet of the nozzle; an actuator operatively coupled to the portion of the nozzle; and an exit area, the outlet of the nozzle disposed in the exit area to direct the exhaust gases into the exit area, the actuator to cause the portion of the nozzle to move to control an amount of ambient air entering the exit area.

Example 10 includes the air vehicle of example 9, wherein the actuator is carried by a frame of the air vehicle.

Example 11 includes the air vehicle of examples 9 or 10, wherein the actuator is carried by a surface of the nozzle.

Example 12 includes the air vehicle of any of examples 9-11, wherein the portion of the nozzle includes a plate, the actuator operatively coupled to a first end of the plate.

Example 13 includes the air vehicle of any of examples 9-12, wherein the actuator is a first actuator and further including a second actuator operatively coupled to a second end of the plate.

Example 14 includes the air vehicle of any of examples 9-13, wherein the portion of the nozzle includes a plate, the actuator to cause the plate to pivot from a first position to a second position to one of increase or decrease the size of the outlet.

Example 15 includes the air vehicle of any of examples 9-14, wherein the actuator is to cause the plate to pivot to decrease the size of the outlet, a size of an opening of the exit area to increase in response to the decrease in the size of the outlet, the opening to receive the ambient air.

Example 16 includes an apparatus comprising a nozzle including an outlet having an adjustable width, the nozzle to provide a flow path for exhaust gases of an engine; an exit area fluidly coupled to the nozzle, the exit area to expel the exhaust gases, an opening defined between the exit area and a portion of the nozzle including the outlet, the opening to receive ambient air to mix with the exhaust gases in the exit area; an actuator to control the width of the nozzle; at least one memory; machine readable instructions; and processor circuitry to execute the machine readable instructions to cause the actuator to control the width of the outlet of the nozzle to adjust a size of the opening defined between the exit area and the portion of the nozzle including the outlet.

Example 17 includes the apparatus of example 16, wherein the processor circuitry is to cause the actuator to decrease the width of the outlet to reduce an infrared signature of a vehicle including the engine.

Example 18 includes the apparatus of examples 16 or 17, wherein the processor circuitry is to cause the actuator to increase the width of the outlet to increase an amount of the exhaust gases expelled via the exit area.

Example 19 includes the apparatus of any of examples 16-18, wherein the actuator is to cause a portion of a wall of the nozzle to move to adjust the width of the outlet.

Example 20 includes the apparatus of any of examples 16-19, wherein the actuator is carried by the nozzle.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An exhaust system comprising:
a nozzle,
a first portion of the nozzle moveable to change a first angle of convergence of the nozzle;
a second portion of the nozzle movable to change a second angle of convergence of the nozzle; and
an exit area, the first portion of the nozzle at least partially in the exit area, a first opening between the exit area and the first portion of the nozzle, a first size of the first opening to change in response to a first movement of the first portion of the nozzle, the second portion of the nozzle at least partially in the exit area, a second opening between the exit area and the second portion of the nozzle, a second size of the second opening to change in response to a second movement of the second portion of the nozzle, the first and second movement in opposite directions.

2. The exhaust system of claim 1, wherein the first portion of the nozzle and the second portion of the nozzle at least partially define an outlet of the nozzle, a size of the outlet to reduce in response to the first movement of the first portion of the nozzle and the second movement of the second portion of the nozzle.

3. The exhaust system of claim 1, wherein the first portion of the nozzle includes a first plate pivotably coupled to a first surface of the nozzle and the second portion of the nozzle includes a second plate pivotably coupled to a second surface of the nozzle.

4. The exhaust system of claim 1, further including an actuator operatively coupled to the first portion of the nozzle and the second portion of the nozzle, the actuator carried by the nozzle.

5. The exhaust system of claim 1, further including a manifold, the manifold, the nozzle, and the exit area defining a flow path for exhaust gases from an engine of an air vehicle, ambient air to enter the exit area via the first opening and the second opening.

6. The exhaust system of claim 1, wherein the nozzle is a first nozzle and further including a second nozzle, the second nozzle including at least two moveable portions, the at least two moveable portions of the second nozzle inwardly moveable toward one another.

7. The exhaust system of claim 6, further including a rib between the first nozzle and the second nozzle.

8. The exhaust system of claim 6, further including a slot defined between the first nozzle and the second nozzle.

9. An air vehicle comprising:
a manifold to receive exhaust gases from an engine of the air vehicle;
a nozzle fluidly coupled to the manifold, at least two portions of the nozzle moveable to adjust a size of an outlet of the nozzle, an inlet of the nozzle beneath the manifold to divert a direction of the exhaust gases entering the manifold from a rearward path to a downward path relative to Earth;
an actuator operatively coupled to the portion of the nozzle; and
an exit area, the outlet of the nozzle in the exit area to direct the exhaust gases into the exit area, the actuator to cause the at least two portions of the nozzle to move to control an amount of ambient air entering the exit area.

10. The air vehicle of claim 9, wherein the actuator is carried by a frame of the air vehicle.

11. The air vehicle of claim 9, wherein the actuator is carried by a surface of the nozzle.

12. The air vehicle of claim 9, wherein the at least two portions of the nozzle respectively include a plate, the actuator operatively coupled respectively to first ends of the plates.

13. The air vehicle of claim 12, wherein the actuator is a first actuator and further including a second actuator operatively coupled respectively to second ends of the plates.

14. The air vehicle of claim 9, wherein the at least two portions of the nozzle each include a plate, the actuator to cause the plates to pivot toward one another to decrease the size of the outlet or away from one another to increase the size of the outlet.

15. The air vehicle of claim 14, wherein the actuator is to cause the plates to pivot to decrease the size of the outlet, a size of an opening of the exit area to increase in response to the decrease in the size of the outlet, the opening to receive the ambient air.

16. An apparatus comprising:
a nozzle including an outlet having an adjustable width;
first and second openings to receive ambient air to mix with exhaust gases in a flow path for exhaust gases of an engine, the first and second openings to increase in size as the width of the adjustable outlet decreases;
an actuator to control the width of the adjustable outlet and the sizes of the first and second openings;
at least one memory;
machine readable instructions; and
processor circuitry to execute the machine readable instructions to cause the actuator to decrease the width of the outlet of the nozzle to increase the sizes of the first opening and the second opening to reduce an infrared signature of a vehicle including the engine.

17. (canceled)

18. The apparatus of claim 16, wherein the processor circuitry is to cause the actuator to increase the width of the outlet to increase an amount of the exhaust gases expelled.

19. The apparatus of claim 16, wherein the actuator is to cause a first wall of the first portion of the nozzle and a second wall of the second portion of the nozzle to move toward or away from one another to adjust the width of the outlet.

20. The apparatus of claim 16, wherein the actuator is carried by the nozzle.

21. The apparatus of claim 16, wherein the actuator is carried by a frame of the vehicle.
